(19) United States
(12) Patent Application Publication
(10) Pub. No.: US 2026/0089499 A1
(43) Pub. Date: Mar. 26, 2026

(54) SYSTEMS AND METHODS FOR MANAGING NETWORK SECURITY KEYS BETWEEN A HOME NETWORK AND A VISITED NETWORK

(71) Applicant: Verizon Patent and Licensing Inc., Basking Ridge, NJ (US)

(72) Inventors: Shanthala KURAVANGI-THAMMAIAH, Keller, TX (US); Vinod Kumar CHOYI, Conshohocken, PA (US); Ye HUANG, San Ramon, CA (US); Yousif TARGALI, Sammamish, WA (US)

(73) Assignee: Verizon Patent and Licensing Inc., Basking Ridge, NJ (US)

(21) Appl. No.: 18/895,577

(22) Filed: Sep. 25, 2024

(51) Int. Cl. H04W 12/06; H04W 12/043; H04W 12/80

(52) U.S. Cl. CPC H04W 12/06; H04W 12/043; H04W 12/80

(57) ABSTRACT

A home network device may receive, from a visited network device, an authentication request for network key information associated with a user equipment roaming in a visited network and utilizing an application service. The home network device may provide, to the visited network device and based on the authentication request, the network key information that includes a set of application function keys with at least an application key identifier and an authentication key identifier associated with the user equipment. The home network device may enable the user equipment to access the application service based on the visited network device provisioning the application service with the network key information.

### BACKGROUND

In the field of telecommunications, secure management of network keys may be critical for ensuring integrity of communications, particularly when subscribers (e.g., user equipments (UEs)) are roaming between a home network and a visited network.

### BRIEF DESCRIPTION OF THE DRAWINGS

FIGS. 1A-1D are diagrams of an example associated with managing network security keys between a home network and a visited network.

FIG. 2 is a diagram of an example environment in which systems and/or methods described herein may be implemented.

FIG. 3 is a diagram of example components of one or more devices of FIG. 2.

FIG. 4 is a flowchart of an example process for managing network security keys between a home network and a visited network.

### DETAILED DESCRIPTION OF EXAMPLE EMBODIMENTS

The following detailed description of example implementations refers to the accompanying drawings. The same reference numbers in different drawings may identify the same or similar elements.

Currently, there is no defined method for securely sharing network keys between a home network and a visited network. Consequently, to meet regulatory requirements, standards bodies have recommended disabling certain authentication and key management for application (AKMA) services during roaming of a UE, leaving network operators without the means to offer such services when subscribers (e.g., UEs) are in visited networks. This lack of process for securely sharing keys restricts network operators'ability to provide continuity of service and to comply with government requirements, including lawful intercept requirements, and presents a major challenge for international telecommunications. Without a secure method to share keys, vital services may need to be disabled during roaming, hindering subscriber experience and impeding network operators'ability to fulfill regulatory and service obligations. Thus, current techniques for handling network keys for a UE roaming in a visited network consume computing resources (e.g., processing resources, memory resources, communication resources, and/or the like), networking resources, and/or other resources associated with failing to comply with lawful intercept requirements for a roaming UE, failing to provide secure communications for a roaming UE, handling poor user experience and theft of data due to failing to provide secure communications for a roaming UE, and/or the like.

Some implementations described herein provide management of network security keys between a home network and a visited network. For example, a home network device may receive, from a visited network device, an authentication request for network key information associated with a user equipment roaming in a visited network and utilizing an application service. The home network device may provide, to the visited network device and based on the authentication request, the network key information that includes a set of application function keys with at least an application key identifier and an authentication key identifier associated with the user equipment. The home network device may enable the user equipment to access the application service based on the visited network device provisioning the application service with the network key information.

In this way, network security keys are managed between a home network and a visited network. For example, a technical framework may be provided for executing secure and consistent network key management across home and visited networks, strengthening telecommunication security infrastructure. By supporting secure authentication and key management for roaming UEs, network operators can maintain service integrity and uniform compliance with government obligations while minimizing the potential for unauthorized access or key tampering. Through the secure management of application-specific keys, the technical framework may maintain network key sharing protocols between a home network and a visited network. The technical framework may foster industry-wide standardization, promote network interoperability, and enhance cross-border security strategies within the telecommunications sector. Thus, the technical framework may conserve computing resources, networking resources, and/or other resources that would have otherwise been consumed by failing to comply with lawful intercept requirements for a roaming UE, failing to provide secure communications for a roaming UE, handling poor user experience and theft of data due to failing to provide secure communications for a roaming UE, and/or the like.

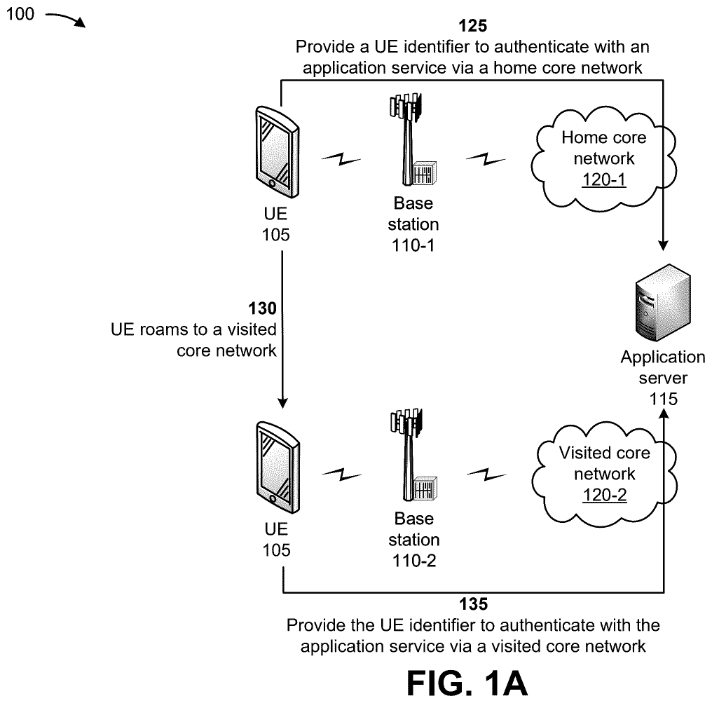

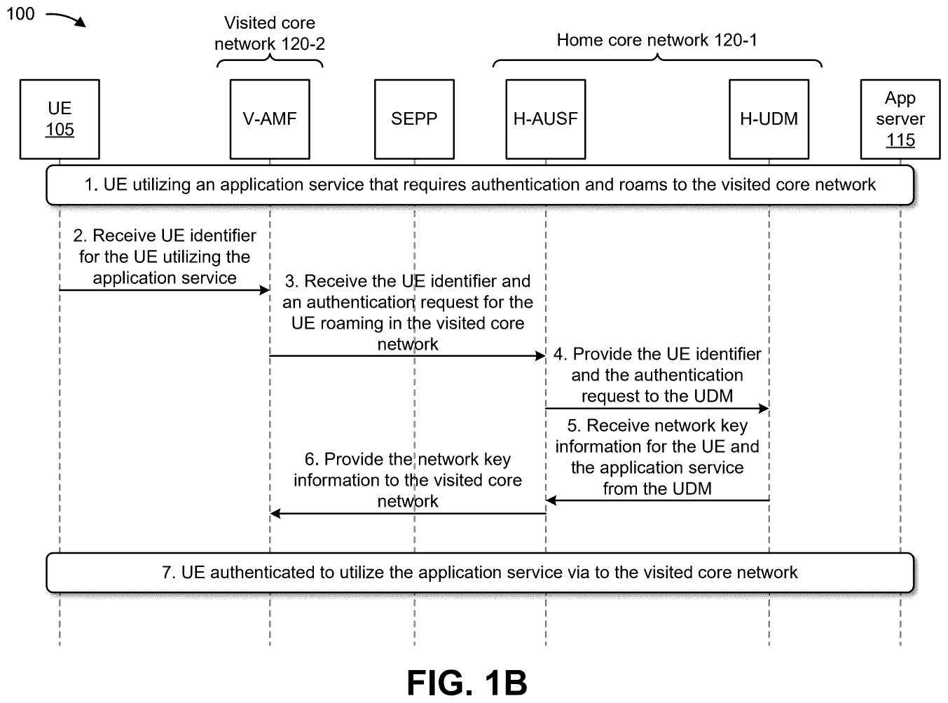

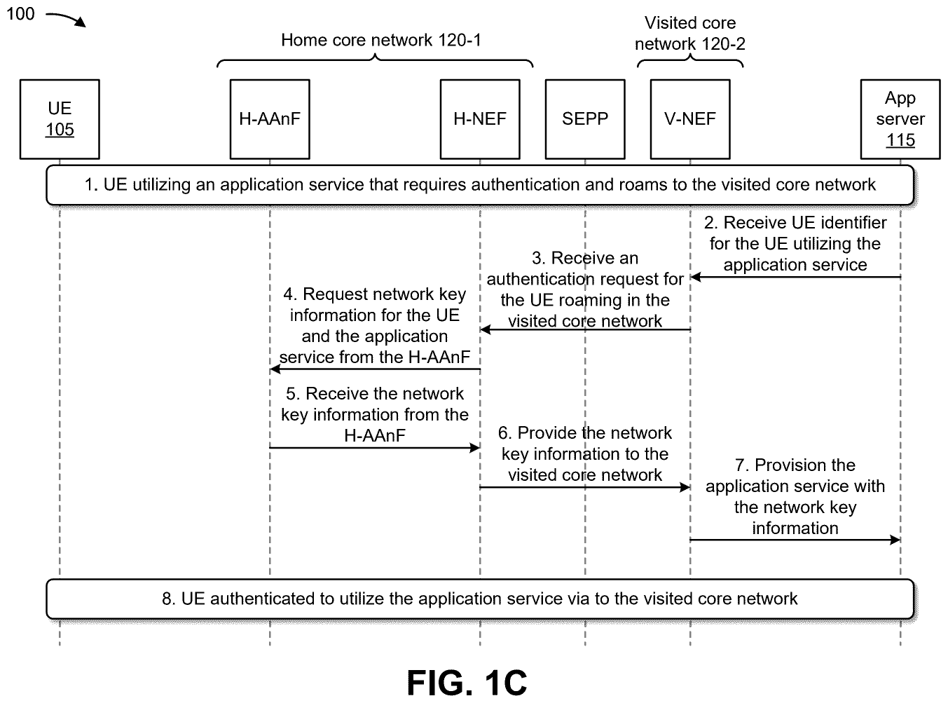

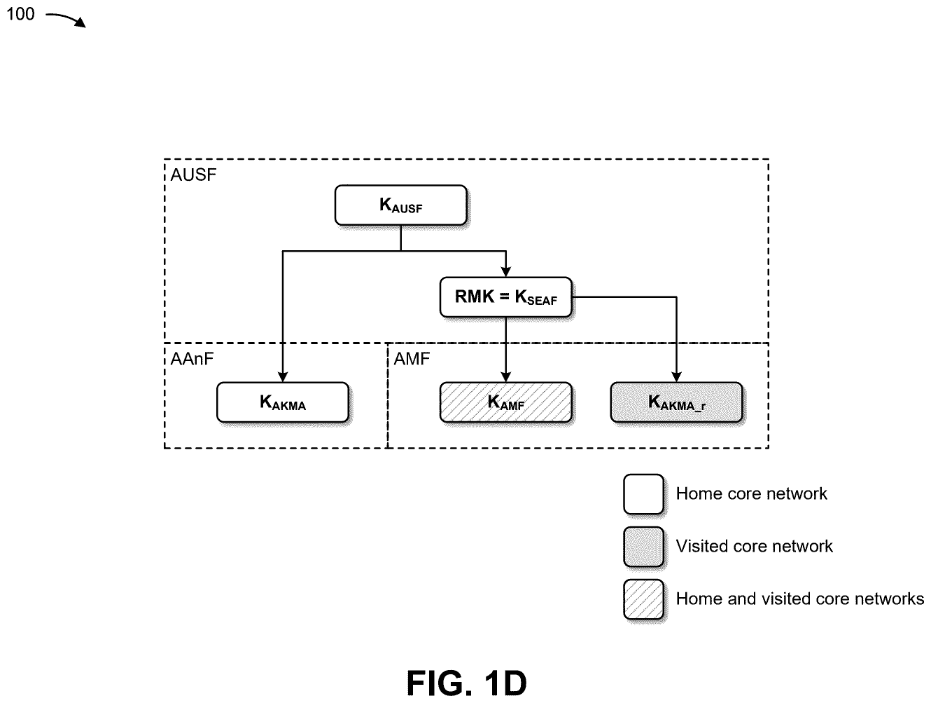

FIGS. 1A-1D are diagrams of an example 100 associated with managing network security keys between a home network and a visited network. As shown in FIGS. 1A-1D, example 100 includes a UE 105 associated with a first base station 110-1, a second base station 110-2, an application server 115, a home core network 120-1, and a visited core network 120-2. Further details of the UE 105, the first base station 110-1, the second base station 110-2, the application server 115, the home core network 120-1, and the visited core network 120-2 are provided elsewhere herein.

As shown in FIG. 1A, and by reference number 125, the UE 105 may provide a UE identifier to authenticate with an application service (e.g., provided by the application server 115) via the home core network 120-1. For example, the UE 105 may transmit an identification signal with a unique identifier inherent to the UE 105, which allows the home core network 120-1 to verify the identity of the UE 105 and establish appropriate credentials and keys necessary for secure communication with application services, such as a service provided by the application server 115. The UE 105 may utilize encryption standards to secure the transfer of the UE identifier. In some implementations, the UE 105 may initiate a primary authentication request by transmitting a unique subscriber identifier, such as a subscription concealed identifier (SUCI), to the home core network 120-1. The home core network 120-1 may utilize the SUCI to validate the identity of the UE 105 and facilitate secure communications, serving as a cornerstone in establishing a trusted association between the UE 105 and the home core network 120-1.

As further shown in FIG. 1A, and by reference number 130, the UE 105 may roam to the visited core network 120-2. For example, the UE 105 may move from a geographical location associated with the home core network 120-1 to a geographical location associated with the visited core network 120-2. When roaming takes place, the UE 105 may maintain the capability to access application services as if the UE 105 were still located in the home core network 120-1. This transition may be facilitated through roaming agreements and technical compatibility between the home core network 120-1 and the visited core network 120-2, which may involve shared standards and secure key exchange protocols. Additionally, or alternatively, the visited core network 120-2 may collaborate with the home core network 120-1 to ensure uninterrupted application service accessibility for the UE 105, by leveraging a secure key exchange mechanism.

As further shown in FIG. 1A, and by reference number 135, the UE 105 may provide the UE identifier to authenticate with the application service (e.g., provided by the application server 115) via the visited core network 120-2. For example, the UE 105 may transmit an identification signal with a unique identifier inherent to the UE 105, which allows the visited core network 120-2 to verify the identity of the UE 105 and establish appropriate credentials and keys necessary for secure communication with application services, such as a service provided by the application server 115. The UE 105 may utilize encryption standards to secure the transfer of the UE identifier. In some implementations, the UE 105 may initiate a primary authentication request by transmitting a unique subscriber identifier, such as a SUCI, to the visited core network 120-2. The visited core network 120-2, in conjunction with the home core network 120-1, may utilize the SUCI to validate the identity of the UE 105 and facilitate secure communications.

Ensuring continued access to the application service (e.g., provided by the application server 115) may require that the visited core network 120-2 recognize the authentication credentials from the UE 105 and facilitate secure communication between the UE and the application server 115. This may involve key information sharing and application function keys that are securely transmitted between the home core network 120-1 and the visited core network 120-2 to prevent interruption of service and to uphold regulatory requirements, such as lawful intercepts. Additionally, or alternatively, during roaming, the UE 105 may utilize one or more of the key information (e.g., that includes an AKMA key (Kₐₖₘₐ), an application function key (K_{af}) and an access key ID (AKID)) that may be shared by the home core network 120-1 with the visited core network 120-2 to securely authenticate and access the application service from the infrastructure of the visited core network 120-2. These keys may maintain the integrity of the authentication and may ensure that the UE 105 can continue to receive the application service without being exposed to security vulnerabilities.

FIG. 1B is an example call flow diagram associated with managing network security keys between a home network and a visited network. As shown in FIG. 1B, a security device (e.g., a security edge protection proxy (SEPP) or a firewall) may be provided between the home core network 120-1 and the visited core network 120-2 to ensure that communications between the home core network 120-1 and the visited core network 120-2 are secure. In some implementations, the SEPP may encrypt communications between the home core network 120-1 and the visited core network 120-2.

As shown at step 1 of FIG. 1B, the UE 105 may be utilizing an application service that requires authentication and may roam from the home core network 120-1 to the visited core network 120-2. For example, the UE 105 may roam from the home core network 120-1 to the visited core network 120-2 and may wish to utilize an application service (e.g., provided by the application server 115) that requires authentication for access. In some implementations, the UE 105 may be utilizing an application service that requires authentication and may roam from the home core network 120-1 to the visited core network 120-2. Additionally, or alternatively, the UE 105 may be utilizing an application service that requires authentication and may roam from the home core network 120-1 to the visited core network 120-2 utilizing a secure token or a certificate that verifies the legitimacy of the UE 105. The secure token and/or the certificate may add a layer of verification to ensure that an application service request is genuine, thereby enhancing the security of roaming authentication.

As shown at step 2, a visited core network device (e.g., a visited access and mobility management function (V-AMF)) may receive a UE identifier for the UE 105 utilizing the application service. For example, when the UE 105 roams to the visited core network 120-2, the UE 105 may generate a UE identifier (e.g., a SUCI), and may provide the UE identifier to the visited core network device (e.g., the V-AMF). In some implementations, the visited core network device (e.g., the V-AMF) may receive additional security parameters or encrypted data along with the UE identifier to further protect against unauthorized access during the roaming process. These additional security parameters can be encrypted to provide an added layer of protection, ensuring that key information remains confidential and secure from potential breaches.

As shown at step 3, a home core network device (e.g., a home authentication server function (H-AUSF)) may receive the UE identifier and an authentication request for the UE 105 roaming in the visited core network 120-2. For example, a home core network device (e.g., the H-AUSF) may receive, from the visited core network device (e.g., the V-AMF), the UE identifier and the authentication request for UE 105 roaming in the visited core network 120-2. In some implementations, the UE identifier and the authentication request may be encrypted by the SEPP prior to being provided to the home core network device (e.g., the H-AUSF). The visited core network device (e.g., the V-AMF) may generate the authentication request and may provide the UE identifier and the authentication request to the home core network device (e.g., the H-AUSF).

As shown at step 4, the home core network device (e.g., the H-AUSF) may provide the UE identifier and the authentication request to another home core network device (e.g., a home unified data management (H-UDM)). For example, the H-UDM may store the network key information (e.g., that includes Kₐₖₘₐ, K_{af}, the AKID, and an application function (AF) identifier (AFID)), and the H-AUSF may request the network key information from the H-UDM based on providing the UE identifier and the authentication request to the H-UDM. In other cases, the H-AUSF may generate the Kₐₖₘₐ, K_{af} and the AKID from the K_{AUSF}. The K_{AUSF} may be provided to the H-AUSF by the H-UDM after the UE 105 has been authenticated by the UDM as part of the primary authentication. If the AUSF performs the network key generation, then the UDM may provide the AKMA subscription data, the AKMA indication, and a routing identifier. Additionally, or alternatively, the H-AUSF may store the network key information. The H-UDM may identify (e.g., in a data structure, such as a database, a table, a list, and/or the like) the network key information based on the UE identifier and the authentication request.

As shown at step 5, the home core network device (e.g., the H-AUSF) may receive the network key information for the UE 105 and the application service from the other home core network device (e.g., H-UDM). For example, the other home core network device (e.g., H-UDM) may provide the network key information for the UE 105 and the application service to the home core network device (e.g., the H-AUSF), and the home core network device (e.g., the H-AUSF) may receive the network key information for the UE 105 and the application service from the other home core network device (e.g., the H-UDM). In some implementations, the network key information may include a set of application function keys that includes an application function identifier, an authentication key identifier associated with the UE 105, a monitoring key for use by a lawful intercept entity, and/or the like. In certain cases, the AKID may be shared by multiple application functions and may be associated with multiple application function identifiers and associated application function keys. In other cases, the AKID may be unique per application function and associated with a unique application function identifier and a unique associated application function key.

As shown at step 6, the home core network device (e.g., H-AUSF) may provide the network key information to the visited core network device (e.g., the V-AMF). For example, the H-AUSF may provide the network key information for the UE 105 and the application service to the V-AMF, and the V-AMF may receive the network key information for the UE 105. In some implementations, the network key information may be encrypted by the SEPP prior to being provided to the visited core network device (e.g., the V-AMF). The V-AMF may store the SUPI and the network key information that includes the AFID, the KAF, the AKID and a time-stamp of when the keys were received.

As shown at step 7, when the UE 105 requests access to the services provided by the application server 115 via the visited core network 120-2, the UE 105 may provide the AKID to the application server 115. The application server 115 may utilize the AKID to identify the home network and the H-UDM that hosts the AKMA function, and may send the AKID to the H-UDM. The H-UDM, based on authorizing the application server 115, may provide to the application server 115 only the relevant network key information (only K_{AF}) associated with the application server 115.

The network key information provided by the home core network 120-1 to the visited core network 120-2 may provide the visited core network 120-2 with the ability for a local lawful intercept function in the visited core network 120-2 to obtain both the network information keys (e.g., the AKID, the KAF, and the AFID) as well as the encrypted traffic that traverses the visited core network 120-2 between the UE 105 and the application server 115. The local lawful intercept function in the visited core network 120-2 may obtain the network information key from the V-AMF using offline or online mechanisms.

FIG. 1C is another example call flow diagram associated with managing network security keys between a home network and a visited network. As shown in FIG. 1C, a security device (e.g., the SEPP or the firewall) may be provided between the home core network 120-1 and the visited core network 120-2 to ensure that communications between the home core network 120-1 and the visited core network 120-2 are secure. In some implementations, the SEPP may encrypt communications between the home core network 120-1 and the visited core network 120-2.

As shown at step 1 of FIG. 1C, the UE 105 may be utilizing an application service that requires authentication and may roam from the home core network 120-1 to the visited core network 120-2. For example, the UE 105 may roam from the home core network 120-1 to the visited core network 120-2 and may wish to utilize an application service (e.g., provided by the application server 115) that requires authentication for access. In some implementations, the UE 105 may be utilizing an application service that requires authentication and may roam from the home core network 120-1 to the visited core network 120-2. Additionally, or alternatively, the UE 105 may be utilizing an application service that requires authentication and may roam from the home core network 120-1 to the visited core network 120-2 utilizing a secure token or a certificate that verifies the legitimacy of the UE 105. The secure token and/or the certificate may add a layer of verification to ensure that an application service request is genuine, thereby enhancing the security of roaming authentication.

As shown at step 2, a visited core network device (e.g., a visited network exposure function (V-NEF)) may receive a UE identifier for the UE 105 utilizing the application service. For example, when the UE 105 roams to the visited core network 120-2, the application server 115 providing the application service may provide a UE identifier (e.g., a SUCI, a GPSI, and the AKID) for the UE 105 to the visited core network device (e.g., the V-NEF), and the V-NEF may receive the UE identifier from the application server 115. In some implementations, the application server 115 may provide an AKMA application key request using the AKID and the UE identifier to the V-NEF. In some implementations, the V-NEF may receive additional information associated with the UE 105, such as a roaming status of the UE 105, intended application services to be utilized by the UE 105, historical data usage patterns of the UE 105, and/or the like. This additional information may assist in tailoring services provided by the visiting core network 120-2 to specific needs and context of the roaming UE 105. The V-NEF may be responsible for handling requests associated with a UE 105 that roams and accesses services within the visited core network 120-2.

As shown at step 3, a home core network device (e.g., a home NEF (H-NEF)) may receive an authentication request for the UE 105 roaming in the visited core network 120-2. For example, the V-NEF may generate the authentication request for the UE 105, and may provide the authentication request to the home core network device (e.g., the H-NEF). The H-NEF may receive an authentication request from the V-NEF. In some implementations, the authentication request may be encrypted by the SEPP prior to being provided to the home core network device (e.g., the H-NEF). The authentication request received by the home core network device may include a request for application-specific keys or an indication of preferred application services of the UE 105. Such additional information in the authentication request may streamline generation or retrieval of network key information that is closely aligned with immediate requests of the UE 105. The H-NEF may act as an intermediary between the roaming UE 105 and other home core network devices responsible for authenticating the roaming UE 105 and providing the network key information to facilitate secure access to application services.

As shown at step 4, the home core network device (e.g., the H-NEF) may request network key information for the UE 105 and the application service from another home core network device (e.g., a home AKMA anchor function (H-AAnF)). For example, based on the authentication request, the home core network device (e.g., the H-NEF) may request network key information for the UE 105 and the application service from the other home core network device (e.g., the H-AAnF). In some implementations, the H-AAnF may store the network key information (e.g., that includes Kₐₖₘₐ, K_{af}, AKID, and an AFID), and the H-NEF may request the network key information from the H-AAnF based on requesting the network key information from the H-AAnF. Additionally, or alternatively, the H-NEF may store the network key information. The H-AAnF may identify (e.g., in a data structure, such as a database, a table, a list, and/or the like) the network key information based on the request. In some implementations, the home core network device (e.g., the H-NEF) may request network key information tailored to specific security protocols supported by the visited core network 120-2 or the application server 115. This may ensure interoperability of security measures between the different networks and services, enabling a seamless and secure user experience for the UE 105.

As shown at step 5, the home core network device (e.g., the H-NEF) may receive the network key information from the other home core network device (e.g., the H-AAnF). For example, the other home core network device (e.g., H-AAnF) may provide the network key information to the home core network device (e.g., the H-NEF), and the home core network device (e.g., the H-NEF) may receive the network key information from the other home core network device (e.g., the H-AAnF). In some implementations, the network key information may include a set of application function keys that includes an application key identifier, an authentication key identifier associated with the UE 105, a monitoring key for use by a lawful intercept entity, and/or the like. Alternatively, or additionally, the home core network device (e.g., H-NEF) may receive temporary network key information that is time-limited and specific to a roaming duration of the UE 105. The H-AAnf may provide additional application function keys KAF that are associated with other application servers 115 a priori if those application servers 115 have pre-registered with the home network or are requested by the V-NEF.

As shown at step 6, the home core network device (e.g., the H-NEF) may provide the network key information to the visited core network device (e.g., the V-NEF). For example, the H-NEF may provide the network key information to the V-NEF, and the V-NEF may receive the network key information from the H-NEF. In some implementations, the network key information may be encrypted by the SEPP prior to being provided to the visited core network device (e.g., the V-NEF). Additionally, or alternatively, the home core network device (e.g., the H-NEF) may generate temporary or session-based key information specifically for a duration of a roaming period of the UE 105 to maintain a higher level of security and revoke the keys once the roaming period expires. Temporary or session-based keys may ensure that access rights are confined to the duration of the roaming period, thereby limiting potential long-term security vulnerabilities.

As shown at step 7, the visited core network device (e.g., V-NEF) may provision the application service with the network key information. For example, the visited core network device (e.g., the V-NEF) may provision the application service with the network key information by transmitting the set of application function keys to the application server 115 for enabling the UE 105 to access the application service. This provisioning enables the application service, which the roaming UE 105 intends to access, to have the necessary keys to establish a secure session with the UE 105. Additionally, or alternatively, the V-NEF may provision the application service with the network key information and an expiration time or usage limit, ensuring that the keys are not used beyond their intended purpose or period. The defined expiration time or usage limit may act as a control mechanism, preventing misuse or overuse of the access rights by the roaming UE 105. Additionally, or alternatively, the visited core network device (e.g., V-NEF) may provision the application service with specific policies or rules that govern the usage of the application service by the roaming UE 105. By incorporating policies and rules, the visited core network 120-2 can enforce necessary constraints and usage parameters that align with service agreements and regulatory standards. Additionally, or alternatively, the network key information provided by the H-NEF to the V-NEF provides the visited core network 120-2 with the ability for a local lawful intercept function in the visited core network 120-2 to obtain both the network information key (e.g., the AKID, the KAF, and the AFID) as well as the encrypted traffic that traverses the visited core network 120-2 between the UE 105 and the application server 115. The local lawful intercept function in the visited core network 120-2 may obtain the network information key from the V-NEF using offline or online mechanisms.

Additionally, or alternatively, the provisioning of the application service may be performed in conjunction with a security verification process to ensure the integrity and confidentiality of the network key information.

As shown at step 8, the UE 105 may be authenticated to utilize the application service via the visited core network 120-2. For example, once the application service is provisioned with the network key information, the UE 105 may be authenticated to utilize the application service via the visited core network 120-2. Additionally, or alternatively, the visited core network device 120-2 perform a real-time check with the home core network 120-1 to validate the network key information before allowing the UE 105 to access the application service. Real-time validation with the home core network 120-1 may ensure that access rights are still valid and that the network key information has not been compromised or invalidated, thus reinforcing the operational security during the roaming scenario.

FIG. 1D is a diagram depicting an example implementation of utilizing a separate roaming AKMA key and a non-roaming AKMA key. As shown, an AUSF of the home core network 120-1 may generate a master key (e.g., K_{SEAF}) as a roaming master key (RMK). An AMF of the visited core network 120-2 may use the RMK to generate K_{AMF} and an AKMA key for roaming (e.g., K_{AKMA_r}). When the UE 105 is roaming, the RMK may be shared by a roaming partner to the AMF of the visited core network 120-2. The RMK may be the SEAF key (e.g., K_{SEAF}) only when the UE 105 is roaming. The AMF may generate the master key (e.g., K_{AMF}) from the RMK and may generate the AKMA key (e.g., K_{AKMA_r}) from the RMK. When roaming, the UE 105 may utilize the SEAF key (e.g., K_{SEAF}) as the RMK for generating the AKMA key (e.g., K_{AKMA_r}). When not roaming, the UE 105 may utilize the master key (e.g., K_{AUSF}) as the master key for generating the AKMA key (e.g., K_{AKMA}). Similarly, when the UE 105 is not roaming, it uses the K_{SEAF} to generate the K_{AMF}. When the UE 105 is not roaming, the AUSF generates the K_{AKMA} using K_{AUSF} as the master key and generates a K_{SEAF} which is shared with the home AMF. The home AMF generates the K_{AMF} from the K_{SEAF} in a non-roaming scenario.

In some implementations, a lawful intercept system may act as an application function when retrieving AKMA key materials. For example, the lawful intercept system in the visited core network 120-2 may act as an application function and may request AKMA keys for target subscribers roaming into the visited core network 120-2. In some implementations, the lawful intercept application function in the visited core network 120-2 may be a trusted application function (e.g., based on technical and contractual security controls) and may request the AKMA keys from the AAnF. In such implementations, the AAnF may support lawful intercept point of interception (PoI) features and may provide the AKMA keys to the lawful intercept application function in the visited core network 120-2 through a lawful intercept infrastructure. Alternatively, the lawful intercept application function in the visited core network 120-2 may be an untrusted application function and may request the AKMA keys via the NEF of the home core network 120-1.

In this way, network security keys are managed between the home core network 120-1 and the visited core network 120-2. For example, a technical framework may be provided for executing secure and consistent network key management across international borders, strengthening telecommunication security infrastructure. By supporting secure authentication and key management for roaming UEs 105, network operators can maintain service integrity and uniform compliance with lawful intercept obligations while minimizing the potential for unauthorized access or key tampering. Through the secure management of application-specific keys, the technical framework may maintain network key sharing protocols between a home network and a visited network. The technical framework may foster industry-wide standardization, promote network interoperability, and enhance cross-border security strategies within the telecommunications sector. Thus, the technical framework may conserve computing resources, networking resources, and/or other resources that would have otherwise been consumed by failing to comply with lawful intercept requirements for a roaming UE 105, failing to provide secure communications for a roaming UE 105, handling poor user experience and theft of data due to failing to provide secure communications for a roaming UE 105, and/or the like.

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

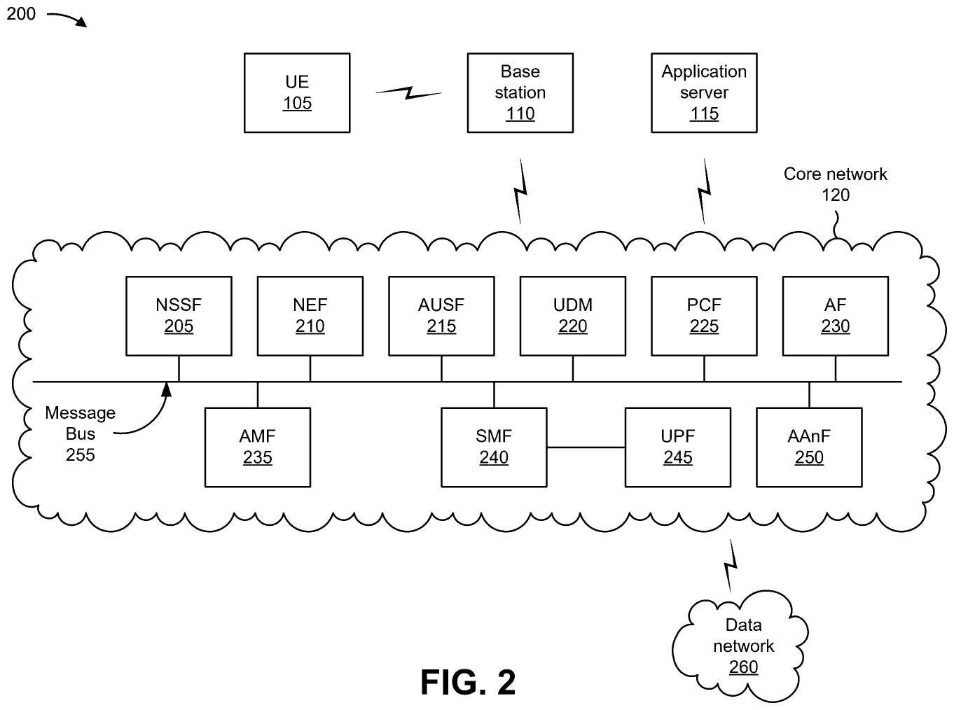

FIG. 2 is a diagram of an example environment 200 in which systems and/or methods described herein may be implemented. As shown in FIG. 2, the example environment 200 may include the UE 105, a base station 110, the application server 115, the core network 120, and a data network 260. Devices and/or networks of the example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The base station 110 may support, for example, a cellular radio access technology (RAT). The base station 110 may include one or more base stations (e.g., base transceiver stations, radio base stations, node Bs, eNodeBs (eNBs) (e.g., the 4G base station 110), gNodeBs (gNBs) (e.g., the 5G base stations 110-1 and 110-2), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The base station 110 may transfer traffic between the UE 105 (e.g., using a cellular RAT), one or more base stations (e.g., using a wireless interface or a backhaul interface, such as a wired backhaul interface), and/or the core network 120. The base station 110 may provide one or more cells that cover geographic areas.

In some implementations, the base station 110 may perform scheduling and/or resource management for the UE 105 covered by the base station 110 (e.g., the UE 105 covered by a cell provided by the base station 110). In some implementations, the base station 110 may be controlled or coordinated by a network controller, which may perform load balancing, network-level configuration, and/or other operations. The network controller may communicate with the base station 110 via a wireless or wireline backhaul. In some implementations, the base station 110 may include a network controller, a self-organizing network (SON) module or component, or a similar module or component. In other words, the base station 110 may perform network control, scheduling, and/or network management functions (e.g., for uplink, downlink, and/or sidelink communications of the UE 105 covered by the base station 110).

The application server 115 includes one or more devices capable of receiving, generating, storing, processing, and/or providing information, such as information described herein. For example, the application server 115 may include a communication device and/or a computing device. For example, the application server 115 may include a server, such as an application server, a client server, a web server, a database server, a host server, a proxy server, a virtual server (e.g., executing on computing hardware), or a server in a cloud computing system. In some implementations, the application server 115 may include computing hardware used in a cloud computing environment.

In some implementations, the core network 120 may include an example functional architecture in which systems and/or methods described herein may be implemented. For example, the core network 120 may include an example architecture of a fifth generation (5G) next generation (NG) core network included in a 5G wireless telecommunications system. While the example architecture of the core network 120 shown in FIG. 2 may be an example of a service-based architecture, in some implementations, the core network 120 may be implemented as a reference-point architecture and/or a 4G core network, among other examples.

As shown in FIG. 2, the core network 120 may include a number of functional elements. The functional elements may include, for example, a network slice selection function (NSSF) 205, a network exposure function (NEF) 210, an authentication server function (AUSF) 215, a unified data management (UDM) component 220, a policy control function (PCF) 225, an application function (AF) 230, an access and mobility management function (AMF) 235, a session management function (SMF) 240, a user plane function (UPF) 245, and/or an AKMA anchor function (AAnF) 250. These functional elements may be communicatively connected via a message bus 255. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the UE 105. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 105 in the wireless telecommunications system.

The UDM 220 includes one or more devices that store user data and profiles in the wireless telecommunications system. The UDM 220 may be used for fixed access and/or mobile access in the core network 120.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples.

The SMF 240 includes one or more devices that support the establishment, modification, and release of communication sessions in the wireless telecommunications system. For example, the SMF 240 may configure traffic steering policies at the UPF 245 and/or may enforce user equipment Internet protocol (IP) address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane quality of service (QoS), among other examples.

The AAnF 250 includes one or more devices that generate key material to be used between the UE 105 and the AF 230 and/or the application server 115, and that maintain AKMA contexts for the UE 105. The AAnF 250 may enable derivation of an AKMA anchor key for an AKMA service (e.g., provided by the application server 115). Before invoking AKMA service, the UE 105 may successfully register with the core network 120, which results in a key being stored at the AUSF 215 and the UE 105 after a successful 5G primary authentication.

The message bus 255 represents a communication structure for communication among the functional elements. In other words, the message bus 255 may permit communication between two or more functional elements.

The data network 260 includes one or more wired and/or wireless data networks. For example, the data network 260 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

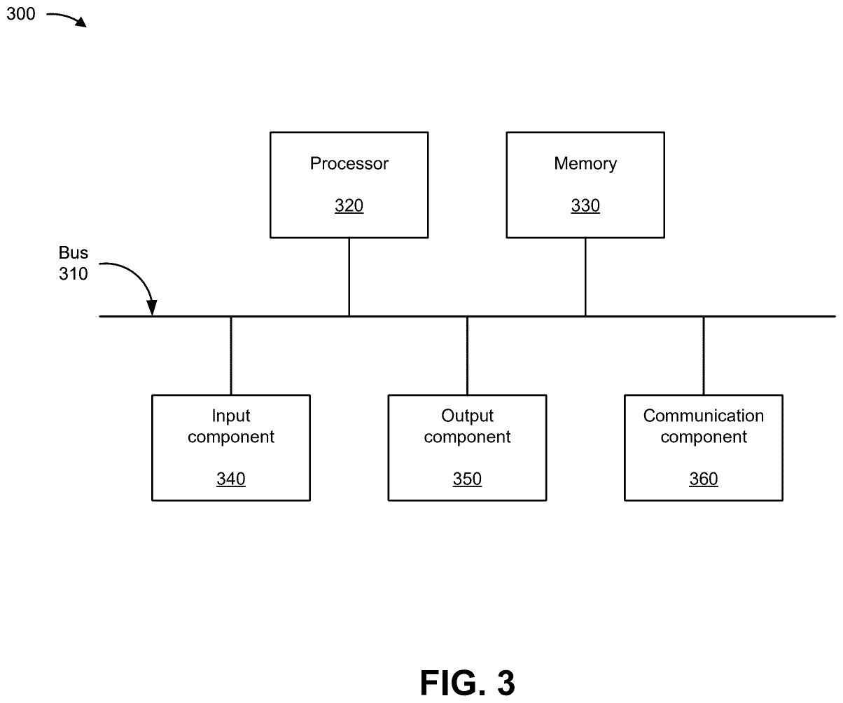

FIG. 3 is a diagram of example components of a device 300, which may correspond to the UE 105, the base station 110, the application server 115, the NSSF 205, the NEF 210, the AUSF 215, the UDM 220, the PCF 225, the AF 230, the AMF 235, the SMF 240, the UPF 245, and/or the AAnF 250. In some implementations, the UE 105, the base station 110, the application server 115, the NSSF 205, the NEF 210, the AUSF 215, the UDM 220, the PCF 225, the AF 230, the AMF 235, the SMF 240, the UPF 245, and/or the AAnF 250 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection).

The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

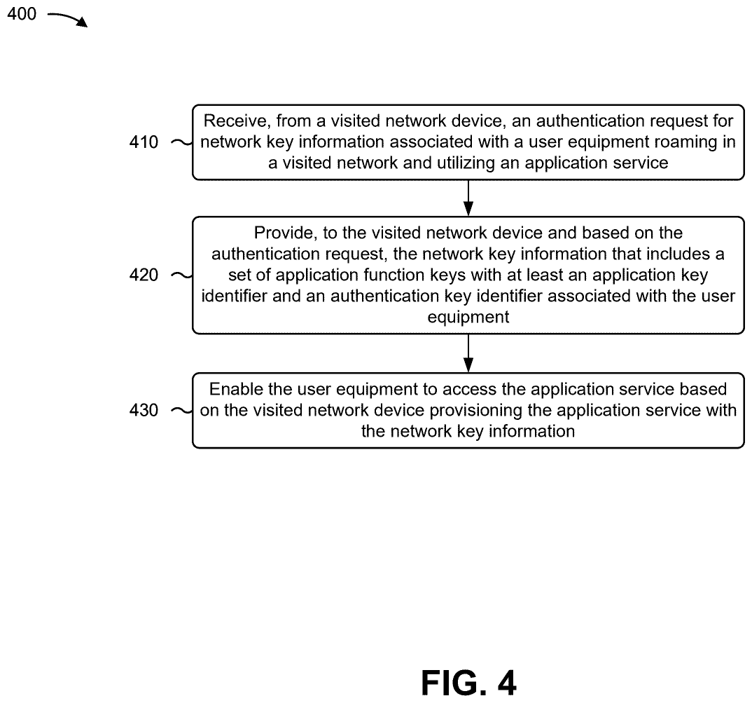

FIG. 4 is a flowchart of an example process 400 for managing network security keys between a home network and a visited network. In some implementations, one or more process blocks of FIG. 4 may be performed by a device (e.g., a network device of the home core network 120-1). In some implementations, one or more process blocks of FIG. 4 may be performed by another device or a group of devices separate from or including the device, such as a network device of the visited core network 120-2. Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving, from a visited network device, an authentication request for network key information associated with a user equipment roaming in a visited network and utilizing an application service (block 410). For example, the home network device may receive, from a visited network device, an authentication request for network key information associated with a user equipment roaming in a visited network and utilizing an application service, as described above. In some implementations, the network key information includes a monitoring key for use by a lawful intercept entity. In some implementations, the home network device is one of an authentication server function or a network exposure function, the visited network device is an access and mobility management function when the home network device is an authentication server function, and the visited network device is a network exposure function when the home network device is a network exposure function.

As further shown in FIG. 4, process 400 may include providing, to the visited network device and based on the authentication request, the network key information that includes a set of application function keys with at least an application key identifier and an authentication key identifier associated with the user equipment (block 420). For example, the home network device may provide, to the visited network device and based on the authentication request, the network key information that includes a set of application function keys with at least an application key identifier and an authentication key identifier associated with the user equipment, as described above. In some implementations, the network key information causes the visited network device to transmit the set of application function keys to an application server for enabling the user equipment to access the application service. In some implementations, providing the network key information to the visited network device includes encrypting the network key information prior to providing the network key information to the visited network device.

In some implementations, the application key identifier provides authentication for the application service utilized by the user equipment. In some implementations, providing the network key information to the visited network device includes utilizing a security device to securely provide the network key information to the visited network device.

As further shown in FIG. 4, process 400 may include enabling the user equipment to access the application service based on the visited network device provisioning the application service with the network key information (block 430). For example, the home network device may enable the user equipment to access the application service based on the visited network device provisioning the application service with the network key information, as described above. In some implementations, the network key information is provided to an application function and a lawful intercept authority application function in the visited network.

In some implementations, process 400 includes authenticating the user equipment based on the authentication request. In some implementations, process 400 includes providing the authentication request to another home network device, and receiving the network key information from the other home network device based on providing the authentication request to the other home network device.

In some implementations, process 400 includes monitoring the set of application function keys for tampering when the network key information is provided to the visited network device. In some implementations, process 400 includes receiving an indication that the network key information is compromised or requires updating, and updating the network key information based on the indication. In some implementations, process 400 includes generating a session-specific key derived using the network key information, and providing the session-specific key to the visited network device to enable localized encryption and decryption of the application service.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more. ” Further, as used herein, the article “the” is intended to include one or more items referenced in connection with the article “the” and may be used interchangeably with “the one or more. ” Furthermore, as used herein, the term “set” is intended to include one or more items (e.g., related items, unrelated items, or a combination of related and unrelated items), and may be used interchangeably with “one or more. ” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either”or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed IS:

1. A method, comprising:
receiving, by a home network device and from a visited network device, an authentication request for network key information associated with a user equipment roaming in a visited network and utilizing an application service;
providing, by the home network device, to the visited network device, and based on the authentication request, the network key information that includes a set of application function keys with at least an application key identifier and an authentication key identifier associated with the user equipment; and
enabling, by the home network device, the user equipment to access the application service based on the visited network device provisioning the application service with the network key information.

2. The method of claim 1, further comprising:
authenticating the user equipment based on the authentication request.

3. The method of claim 1, wherein the network key information includes a monitoring key for use by an intercept entity.

4. The method of claim 1, wherein the network key information causes the visited network device to transmit the set of application function keys to an application server for enabling the user equipment to access the application service.

5. The method of claim 1, further comprising:
providing the authentication request to another home network device; and
receiving the network key information from the other home network device based on providing the authentication request to the other home network device.

6. The method of claim 1, wherein providing the network key information to the visited network device comprises:
encrypting the network key information prior to providing the network key information to the visited network device.

7. The method of claim 1, wherein the home network device is one of an authentication server function or a network exposure function, the visited network device is an access and mobility management function when the home network device is an authentication server function, and the visited network device is a network exposure function when the home network device is a network exposure function.

8. A network device, comprising:
one or more processors configured to:
receive, from a visited network device, an authentication request for network key information associated with a user equipment roaming in a visited network and utilizing an application service;
encrypt the network key information;
provide, to the visited network device and based on the authentication request, the network key information that includes a set of application function keys with at least an application key identifier and an authentication key identifier associated with the user equipment; and
enable the user equipment to access the application service based on the visited network device provisioning the application service with the network key information.

9. The network device of claim 8, wherein the network key information is provided to an application function and an intercept authority application function in the visited network.

10. The network device of claim 8, wherein the one or more processors are further configured to:
monitor the set of application function keys for tampering when the network key information is provided to the visited network device.

11. The network device of claim 8, wherein the application key identifier provides authentication for the application service utilized by the user equipment.

12. The network device of claim 8, wherein the one or more processors are further configured to:
receive an indication that the network key information is compromised or requires updating; and
update the network key information based on the indication.

13. The network device of claim 8, wherein the one or more processors are further configured to:
generate a session-specific key derived using the network key information; and
provide the session-specific key to the visited network device to enable localized encryption and decryption of the application service.

14. The network device of claim 8, wherein the one or more processors, to provide
the network key information to the visited network device, are configured to:
utilize a security device to securely provide the network key information to the visited network device.

15. A non-transitory computer-readable medium storing a set of instructions, the set of instructions comprising:
one or more instructions that, when executed by one or more processors of a network device, cause the network device to:
receive, from a visited network device, an authentication request for network key information associated with a user equipment roaming in a visited network and utilizing an application service;
provide, to the visited network device and based on the authentication request, the network key information that includes a set of application function keys with at least an application key identifier and an authentication key identifier associated with the user equipment,
wherein the application key identifier provides authentication for the application service utilized by the user equipment; and
enable the user equipment to access the application service based on the visited network device provisioning the application service with the network key information.

16. The non-transitory computer-readable medium of claim 15, wherein the network key information causes the visited network device to transmit the set of application function keys to an application server for enabling the user equipment to access the application service.

17. The non-transitory computer-readable medium of claim 15, wherein the one or more instructions further cause the network device to:
provide the authentication request to another network device; and
receive the network key information from the other network device based on providing the authentication request to the other network device.

18. The non-transitory computer-readable medium of claim 15, wherein the one or more instructions, that cause the network device to provide the network key information to the visited network device, cause the network device to:
encrypt the network key information prior to providing the network key information to the visited network device.

19. The non-transitory computer-readable medium of claim 15, wherein the one or more instructions further cause the network device to:
monitor the set of application function keys for tampering when the network key information is provided to the visited network device.

20. The non-transitory computer-readable medium of claim 15, wherein the one or more instructions further cause the network device to:
receive an indication that the network key information is compromised or requires updating; and
update the network key information based on the indication.
